(19) United States
(12) Patent Application Publication
(10) Pub. No.: US 2005/0128353 A1
(43) Pub. Date: Jun. 16, 2005

(54) System and method for using second remote control device for sub-picture control in television receiver

(76) Inventors: Bruce A. Young, Le Mars, IA (US); Robert J. Burnett, Dakota Dunes, SD (US); Ken Lowe, San Juan Capistrano, CA (US)

Correspondence Address: SUITER- WEST PC LLC, 14301, FNB PARKWAY SUITE 320, OMAHA, NE, 68154, US

(21) Appl. No.: 10/834,489

(22) Filed: Apr. 29, 2004

Related U.S. Application Data
(60) Provisional application No. 60/529,886, filed on Dec. 16, 2003.
(60) Provisional application No. 60/529,886, filed on Dec. 16, 2003.

(51) Int. Cl. H04N 5/268; H04N 5/44

(52) U.S. Cl. 348/588; 348/734

(57) ABSTRACT

The present invention is directed to a system and method for using a second remote control device for sub-picture control in a television receiver. The present invention may enable two viewers watching independent video contents on a television receiver to independently control their own viewing experience of channel, volume, and the like, with minimal interaction required between the two viewers to coordinate their activities. According to an exemplary aspect of the present invention, a television system may include a television receiver for displaying a main window and a secondary window on a screen of the television receiver. The main window shows first video content, and the secondary window shows second video content. The television system may further include a first remote control device for controlling the first video content and a second remote control device for controlling the second video content. Both remote control devices are communicatively coupled to the television receiver.

### CROSS-REFERENCE TO RELATED DOCUMENTS

The present application claims the benefit under 35 U.S.C. § 119(e) of U.S. Provisional Application Ser. No. 60/529,886, filed Dec. 16, 2003. Said U.S. Provisional Application Ser. No. 60/529,886 is herein incorporated by reference in its entirety.

### FIELD OF THE INVENTION

The present invention generally relates to a television system, and particularly to a system and method for using a second remote control device for sub-picture control in a television receiver.

### BACKGROUND OF THE INVENTION

A widescreen television is a television having a screen with an aspect ratio of 16:9. An aspect ratio is a ratio of width to height. Currently, anew usage model is emerging in widescreen televisions. Since most content is still only available in an aspect ratio of 4:3, it is possible to watch two independent video contents side by side on a widescreen television, either stretched to fill the screen or “letter-boxed” in their proper aspect ratios. Many widescreen televisions offer audio for the second video content (sub-picture) on a headphone jack. Since this is a fundamentally different viewing experience from the old PIP (picture-in-picture) functionality, offering the ability for two different people to watch and listen to two independent video contents, it may lead to a “control” problem with a single remote control device. Thus, there is a need to provide a system and method for satisfying the needs of the second viewer watching the “sub-picture” programming and listening on the headphone for controlling his/her own viewing experience.

### SUMMARY OF THE INVENTION

Accordingly, the present invention is directed to a system and method for using a second remote control device for sub-picture control in a television receiver. The present invention may enable two viewers watching independent video contents on a television receiver to independently control their own viewing experience of channel, volume, and the like, with minimal interaction required between the two users to coordinate their activities.

According to an exemplary aspect of the present invention, a television system may include a television receiver for displaying a main window and a secondary window on a screen of the television receiver. The main window shows first video content, and the secondary window shows second video content. The television system may further include a first remote control device for controlling the first video content and a second remote control device for controlling the second video content. Both remote control devices are communicatively coupled to the television receiver.

According to an additional exemplary aspect of the present invention, a method for controlling a secondary window on a screen of a television receiver, the screen having a main window in addition to the secondary window, the main window showing first video content, the secondary window showing second video content, may include the following steps: (1) changing the first video content via a first remote control device; and (2) changing the second video content via a second remote control device.

According to another exemplary aspect of the present invention, a method for identifying remote control devices may include the following steps: (1) assigning a Remote ID to a remote control device; and (2) sending out a command with a string “Brand ID+Command+Remote ID” from the remote control device.

According to a further exemplary aspect of the present invention, an apparatus for controlling a secondary window on a screen of a television receiver, the screen having a main window in addition to the secondary window, the main window showing first video content, the secondary window showing second video content, may include means for changing the first video content via a first remote control device and means for changing the second video content via a second remote control device.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows an exemplary television system in accordance with an exemplary embodiment of the present invention; and

FIG. 2 shows an exemplary method for controlling a secondary window on a screen of a television receiver in accordance with an exemplary embodiment of the present invention, where the screen has a main window in addition to the secondary window, the main window shows first video content, and the secondary window shows second video content.

### DETAILED DESCRIPTION OF THE INVENTION

Reference will now be made in detail to the presently preferred embodiments of the invention, examples of which are illustrated in the accompanying drawings.

The present invention, through using a second remote control device, may enable two viewers watching independent video contents on a television receiver to independently control their own viewing experience of channel, volume, and the like, with minimal interaction required between the two users to coordinate their activities.

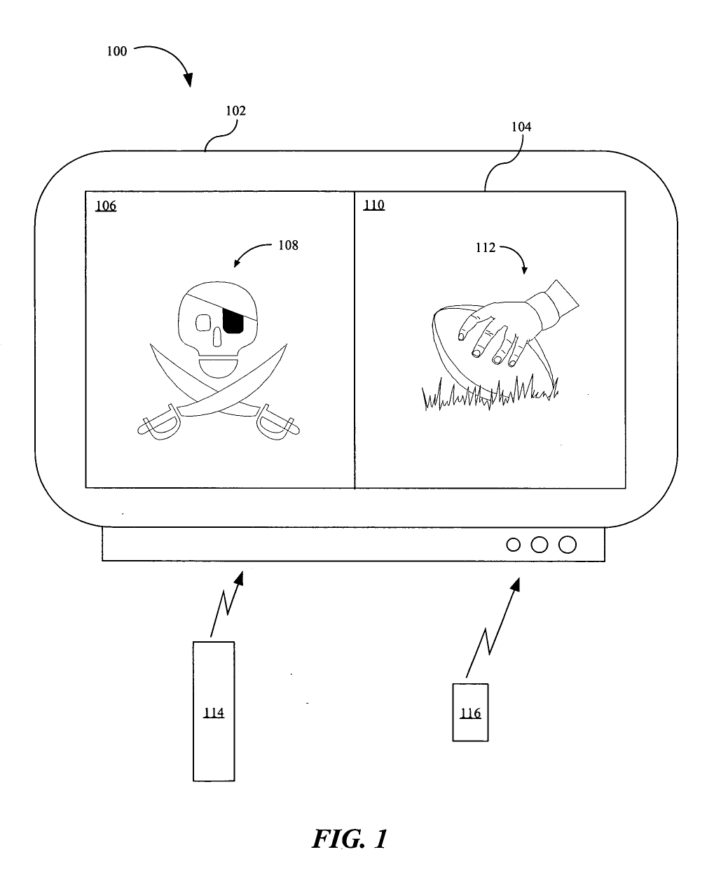

Referring now to FIG. 1, an exemplary television system 100 in accordance with an exemplary embodiment of the present invention is shown. The television system 100 may include a television receiver 102 for displaying on its screen 104 video content from video sources such as a television channel, a video tape, a DVD (digital versatile disc), a VCD (video compact disc), a SVCD (super video compact disc), and the like. The screen 104 may have an aspect ratio of 16:9, 4:3, or the like. An aspect ratio is a ratio of width to height. Preferably, the screen 104 has an aspect ratio of 16:9. The screen 104 may include a main window 106 for showing first video content 108 and a secondary window 110 for showing second video content 112. F or example, the main window 106 may show the first video content 108 of a television channel, and the secondary window 110 may show the second video content 112 of a different television channel. It is understood that the video content 108 or 112 may be from any video source such as a television channel, a video tape, a DVD, a VCD, a SVCD, and the like without departing from the scope and spirit of the present invention.

When the secondary window 110 is positioned within the borders of the main window 106, this display format is called a PIP (picture-in-picture) format. Thus, in the PIP format, the second video content 112 encroaches on the first video content 108. When the secondary window 110 is positioned outside the main window 106, this display format is called a POP (picture-outside-picture) format. Typically, in the POP format, the secondary window 110 is positioned along the side, top, or bottom of the main window 106. Thus, in the POP format, the second video content 112, instead of encroaching on the first video content 108, is boxed next to the first video content 108. His/her format is a special kind of POP format, where the main window 106 and the secondary window 110 are displayed side by side on the screen 104 (see, e.g., FIG. 1).

Using the television system 100, a first viewer may watch the first video content 108 and a second viewer may watch the second video content 112 simultaneously. Preferably, at least one viewer watches the video content with a headphone for receiving audio for the video content to minimize sound interference between the two viewers. The headphone is communicatively coupled to the television receiver 102. For example, the second viewer may watch the second video content 112 with a headphone for receiving audio for the second video content 112 while the first viewer may receive audio for the first video content 108 through the speaker of the television receiver 102. In an additional embodiment, the first viewer may watch the first video content 108 with a headphone for receiving audio for the first video content 108 while the second viewer may receive audio for the second video content 112 through the speaker of the television receiver 102. In a further embodiment, both viewers may each use a separate headphone to receive their respective audio.

The television system 100 may further include a first remote control device 114 for changing the first video content 108 and a second remote control device 116 for changing the second video content 112. The second remote control device 116 may be substantially different and easily distinguishable from the first remote control device 114 in order to minimize user confusion.

Preferably, the first remote control device 114 and the second remote control device 116 each emit a unique signal so that the television receiver 102 knows which signal is from which remote control device. In an exemplary embodiment, the first remote control device 114 and the second remote control device 116 use different coded commands. The first remote control device 114 may send coded commands that change the main window 106, and the second remote control device 116 may send coded commands that change the secondary window 110. For example, the first remote control device 1 14 may send the code 06 to increase the channel number by “1” in the main window 106, and the second remote control device 116 may send the code 16 to increase the channel number by “1” in the secondary window 110.

Typically, a remote control device sends out a command with a string “Brand ID+Command”. In an exemplary embodiment of the present invention, each remote control device may be assigned an individual Remote ID at the time of manufacture so that the string may be “Brand ID+Command+Remote ID”. Preferably, every remote control device may be assigned a unique Remote ID. For example, a manufacturer may use the Remote ID in a 16-bit format, or the like. The first remote control device built may have a Remote ID “0000000000000001”. Only after a remote control device with a Remote ID of “1111111111111111” has been built does the Remote ID returns to “0000000000000001”. This may make it unlikely that two or more remote control devices with the same Remote ID could ever find their way into the same environment. Thus, in FIG. 1, the first remote control device 114 and the second remote control device 116 may each have a unique Remote ID so that the television receiver 102 knows which signal is from which remote control device.

The use of a Remote ID for a remote control device may have the following additional advantages. First, in the case of an environment like interactive TV, the TV may be notified that two different users with two different remote control devices are in the room. Thus, polls, questions, and the like may be asked of both parties and each party may respond with his or her own remote control device. Games may also be played using this feature. Moreover, in the case where two devices are capable of responding to two remote control devices, each device may be designed to respond only to commands from a specific remote control device.

The second remote control device 116 may include at least one of the following control buttons, dials, knobs, and the like for controlling the secondary window 110:
(1) Secondary Window On/Off—This toggles between a full main window only on the screen and the last display format selected. Thus, the secondary window may be turned on or off via the second remote control device;
(2) Display Format—This rotates among a PIP format, a POP format, his/her format, and the like;
(3) Window Size—This lets the user select a size of the secondary window, either increased or decreased in a continuous manner or selected among a plurality of pre-determined sizes;
(4) Window Location—This lets the user move the location of the secondary window in a PIP or POP format either continuously or between pre-selected locations;
(5) Window Channel—This lets the user control the television channel selected in the secondary window using a second tuner when the source of the second video content is a television channel. The second tuner may either be up/down only or a direct select keypad. Up/Down is the preferred embodiment to keep the second remote control device simple;
(6) Window Volume—This lets the user control a volume level of audio for the second video content (preferably the audio is received by a headphone);
(7) Window Source—This lets the user choose which video source to use for the secondary window by selecting from a plurality of available video sources; and
(8) Window Aspect Ratio—This lets the user choose the aspect ration of the secondary window as 16:9, 4:3, or the like.

According to an aspect of the present invention, the first remote control device 114 may also be able to turn the secondary window 110 on and off. Preferably, once the secondary window 110 is turned on by either the first remote control device 114 or the second remote control device 116, the first remote control device 114 no long has any control on the secondary window 110 other than turning the secondary window 110 off. Alternatively, once the secondary window 110 is turned on by either the first remote control device 114 or the second remote control device 116, the first remote control device 114 no long has any control on the secondary window 110, and the secondary window 110 is solely controlled via the second remote control device 116.

It is understood that the foregoing described control buttons, dials, knobs, and the like on the second remote control device 116 may be set up on the television receiver 102 as well without departing from the scope and spirit of the present invention.

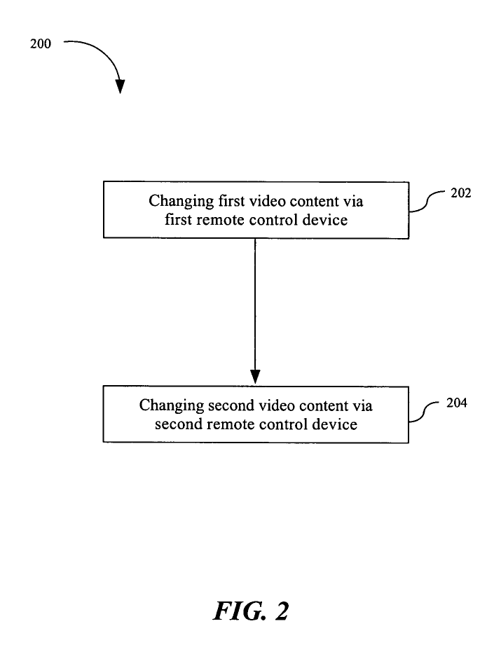

FIG. 2 shows an exemplary method or process 200 for controlling a secondary window on a screen of a television receiver in accordance with an exemplary embodiment of the present invention, where the screen has a main window in addition to the secondary window, the main window shows first video content, and the secondary window shows second video content. The process 200 may start with a step 202 in which the first video content is changed via a first remote control device. Next, the second video content is changed via a second remote control device 204. Both remote control devices are communicatively coupled to the television receiver. The first video content and/or the second video content may be from any video source such as a television channel, a video tape, a DVD, a VCD, a SVCD, and the like without departing from the scope and spirit of the present invention. The secondary window may be turned on or off via either the first remote control device or the second remote control device. The second remote control device may be able to change features of the secondary window such as a display format (PIP, POP, his/her, or the like), a window size, a window location, a window channel (when a source of the second video content is a television channel), a window volume (a volume level of audio for the second video content), a window source (a video source for the secondary window), a window aspect ratio, and the like.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A television system, comprising:
a television receiver for displaying a main window and a secondary window on a screen of said television receiver, said main window showing first video content, and said secondary window showing second video content;
a first remote control device, communicatively coupled to said television receiver, for controlling said first video content; and
a second remote control device, communicatively coupled to said television receiver, for controlling said second video content.

2. The television system of claim 1, wherein said screen has an aspect ratio of 16:9.

3. The television system of claim 1, wherein said second remote control device is substantially different from said first remote control device.

4. The television system of claim 1, wherein said second remote control device is capable of turning said secondary window on and off.

5. The television system of claim 1, wherein said second remote control device is capable of placing said main window and said secondary window in at least one of a picture-in-picture format, a picture-outside-picture format, and his/her format.

6. The television system of claim 1, wherein said second remote control device is capable of moving a location of said secondary window either continuously or among a plurality of pre-determined locations when said secondary window and said main window are in a picture-in-picture or a picture-outside-picture format.

7. The television system of claim 1, wherein said second remote control device is capable of adjusting a size of said secondary window.

8. The television system of claim 7, wherein said size of said secondary window may be increased or decreased in a continuous manner.

9. The television system of claim 7, wherein said size of said secondary window is selected among a plurality of pre-determined sizes.

10. The television system of claim 1, wherein, when a source of said second video content is a television channel, said second remote control device changes said television channel through an up/down button on said second remote control device.

11. The television system of claim 1, wherein, when a source of said second video content is a television channel, said second remote control device changes said television channel through a direct select keypad on said second remote control device.

12. The television system of claim 1, further comprising a headphone, said headphone being communicatively coupled to said television receiver and receiving audio for said second video content.

13. The television system of claim 12, wherein said second remote control device is capable of adjusting a volume level of said audio for said second video content.

14. The television system of claim 12, further comprising a second headphone, said second headphone being communicatively coupled to said television receiver and receiving audio for said first video content.

15. The television system of claim 1, wherein said second remote control device is capable of selecting a video source for said secondary window by selecting among a plurality of available video sources.

16. The television system of claim 1, wherein said second remote control device is capable of selecting an aspect ratio of said secondary window as 4:3 or 16:9.

17. The television system of claim 1, wherein said second remote control device uses coded commands different from said first remote control device.

18. The television system of claim 1, wherein said second remote control device sends out a command with a string “Brand ID+Comm and +Remote ID”.

19. The television system of claim 1, wherein said Remote ID is a 16-bit format.

20. The television system of claim 1, wherein said Remote ID is assigned at time of manufacture.

21. A method for controlling a secondary window on a screen of a television receiver, said screen having a main window in addition to said secondary window, said main window showing first video content, and said secondary window showing second video content, comprising:
changing said first video content via a first remote control device; and
changing said second video content via a second remote control device.

22. The method of claim 21, further comprising receiving audio for said second video content via a headphone, said headphone being communicatively coupled to said television receiver.

23. The method of claim 22, wherein a volume level of said audio for said second video content is changed via said second remote control device.

24. The method of claim 22, further comprising receiving audio for said first video content via a second headphone, said second headphone being communicatively coupled to said television receiver.

25. The method of claim 24, wherein a volume level of said audio for said first video content is changed via said first remote control device.

26. The method of claim 21, further comprising turning said secondary window on and off via said second remote control device.

27. The method of claim 21, further comprising placing said main window and said secondary window in at least one of a picture-in-picture format, a picture-outside-picture format, and his/her format via said second remote control device.

28. The method of claim 21, further comprising moving a location of said secondary window either continuously or among a plurality of pre-determined locations via said second remote control device when said secondary window and said main window are in a picture-in-picture or a picture-outside-picture format.

29. The method of claim 21, further comprising adjusting a size of said secondary window via said second remote control device.

30. The method of claim 29, wherein said size of said secondary window may be increased or decreased in a continuous manner via said second remote control device.

31. The method of claim 29, wherein said size of said secondary window is adjusted among a plurality of pre-determined sizes via said second remote control device.

32. The method of claim 21, wherein, when a source of said second video content is a television channel, said second remote control device changes said television channel through an up/down button on said second remote control device.

33. The method of claim 21, wherein, when a source of said second video content is a television channel, said second remote control device changes said television channel through a direct select keypad on said second remote control device.

34. The method of claim 21, further comprising selecting a video source for said secondary window by selecting among a plurality of available video sources via said second remote control device.

35. The method of claim 34, wherein said video source is a television channel.

36. The method of claim 21, further comprising selecting an aspect ratio of said secondary window as 4:3 or 16:9 via said second remote control device.

37. A method for identifying remote control devices, comprising:
assigning a Remote ID to a remote control device; and
sending out a command with a string “Bran d ID+Command+Remote ID” from said remote control device.

38. The method of claim 37, wherein said Remote ID is assigned at time of manufacture.

39. The method of claim 37, wherein said Remote ID is in a 16-bit format.

40. The method of claim 37, wherein different Remote IDs are assigned to different remote control devices.

41. An apparatus for controlling a secondary window on a screen of a television receiver, said screen having a main window in addition to said secondary window, said main window showing first video content, and said secondary window showing second video content, comprising:
means for changing said first video content via a first remote control device; and
means for changing said second video content via a second remote control device.
